(19) United States
(12) Patent Application Publication
(10) Pub. No.: US 2016/0008895 A1
(43) Pub. Date: Jan. 14, 2016

(54) TUBE CUTTER

(71) Applicant: YU-CHUAN CHEN, CHANGHUA COUNTY (TW)

(72) Inventor: YU-CHUAN CHEN, CHANGHUA COUNTY (TW)

(21) Appl. No.: 14/328,935

(22) Filed: Jul. 11, 2014

(51) Int. Cl. B23D 21/08

(52) U.S. Cl. CPC B23D 21/08

(57) ABSTRACT

A tube cutter is revealed. A moveable member is mounted into a main body by a rod portion inserted into a slot of the main body. At the same time, a jagged positioning portion on a positioning block of the main body is positioned on a jagged stopping portion of the rod portion by a pressing elastic part. An elastic pressing member includes a supporting elastic part disposed between a mounting projection and a mounting hole of the main body. A sliding block on bottom of the elastic pressing member is mounted in a sliding groove of the main body while sliding distance of the sliding block is restricted by a stopping rod in a stopping hole. A cutting blade of the moveable member is tightly against a tube due to the elastic pressing member being pushed by the supporting elastic part. Thus the tube is cut smoothly.

### BACKGROUND OF THE INVENTION

1. Fields of the Invention

The present invention relates to a tube cutter, especially to a tube cutter that cuts tubes smoothly without adjusting the tightness between the tube and a cutting blade. Thus the tube cutter is easy-operated and convenient to use.

2. Descriptions of Related Art

While cutting various tubes during construction processes, builders use tube cutters for cutting these tubes. The tube cutter includes a C-shaped body, a plurality of rotatable wheels arranged on a front end thereof, a mounting tube corresponding to the wheels disposed on a rear end thereof, and a locking member near the mounting tube. The locking member is moveable while being pressed. Moreover, a moveable sleeve can be connected to the mounting tube of the body to form a hollow rod. An inner surface of the sleeve is disposed with an internal thread while an outer surface of the sleeve is arranged with a plurality of positioning grooves that is corresponding to the locking member. An actuating rod with a blade is connected to the sleeve. One end of the actuating rod with the sleeve is extended toward the wheels while the blade is set on this end of the actuating rod with the sleeve. The other end of the actuating rod is connected to an operating head and engaged with the internal thread of the sleeve. While in use, the tube to be cut is set on one end of the wheels of the body. Then the locking member is pressed to be released from the positioning groove of the sleeve and the sleeve is pushed to move toward the wheels. Thus the blade of the actuating rod is leaning against an outer surface of the tube to be cut. Now rotate the body in relative to the tube so as to make the blade rotate along the outer surface of the tube. At the same time, the operating head is rotated to push the actuating rod moving toward the wheels. Thus the tube is cut by the blade.

Although the tube cutter achieves the expected function, it has certain shortcomings. While in use, the tube has a certain thickness. Thus the blade of the actuating rod cuts the outer surface of the tube while the blade is leaning against the outer surface of the tube. The tube is unable to be cut completely at a time. The tube cutter needs to be adjusted over and over again to make the blade of the actuating rod press against the outer surface of the tube tightly for smooth cutting of the tube. Thus there is room for improvement and there is a need to provide a novel tube cutter.

### SUMMARY OF THE INVENTION

Therefore it is a primary object of the present invention to provide a tube cutter in which a cutting blade of a moveable member is pressed against a tube tightly by an elastic pressing member during a cutting process. The elastic pressing member is pushed by a supporting elastic part arranged between a main body and the elastic pressing member. Thus there is no need to repetitively adjust the tightness between the tube and the cutting blade and the cutting of the tube is completed smoothly. The tube cutter is easily-operated and convenient to use.

In order to achieve the above object, a tube cutter of the present invention includes a main body, a moveable member and an elastic pressing member.

A slot is mounted on a lower part of the main body. A penetrating opening hole for moveably mounting a positioning block is arranged at the slot. A positioning hole is arranged at and penetrating through one side surface of the positioning block and a jagged positioning portion is formed on a bottom surface of the positioning block. A positioning projection is disposed on the bottom surface of the main body at the position corresponding to the opening hole and a pressing elastic part is arranged around the positioning projection. A press member is disposed on and against a bottom end of the pressing elastic part. A lug is projecting upward from each of two sides of the press member and a positioning hole corresponding to the positioning hole of the positioning block is mounted on each lug. A long hole that is corresponding to the positioning hole of the positioning block and used for mounting a positioning rod is set on the main body. By the positioning rod being passed through the long hole, the positioning holes on the lugs of the press member and the positioning hole of the positioning block, the positioning block together with the pressing elastic part and the press member is assembled on the main body. Moreover, mounting holes are mounted on the main body, over the slot. A sliding groove is formed on the main body, located between the slot and the mounting holes. A stopping hole is set on an outer end of the sliding groove and is used for receiving a stopping rod.

The moveable member includes a rod portion and a cutting blade. The rod portion is extended from one end thereof and corresponding to the slot of the main body. A jagged stopping portion is formed on a top surface of the rod portion and is corresponding to the jagged positioning portion of the positioning block of the main body. The cutting blade is pivotally connected to one side of the moveable member facing the main body.

The elastic pressing member includes mounting projections corresponding to the mounting holes of the main body. A supporting elastic part is arranged between the mounting projection and the mounting hole of the main body. A sliding block corresponding to the sliding groove of the main body is disposed on the bottom of the elastic pressing member. Thus the elastic pressing member is sliding in the sliding groove by the sliding block and is stopped by the stopping rod in the stopping hole of the main body. Two rotating wheels corresponding to the cutting blade of the moveable member are pivotally connected to the elastic pressing member.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is an assembled view of an embodiment according to the present invention;

FIG. 3 is a cross sectional view of an assembled embodiment according to the present invention;

FIG. 4 is a schematic drawing showing an embodiment of the present invention being adjusted;

FIG. 5 is a schematic drawing showing an embodiment of the present invention in use.

### DETAILED DESCRIPTION OF THE PREFERRED EMBODIMENT

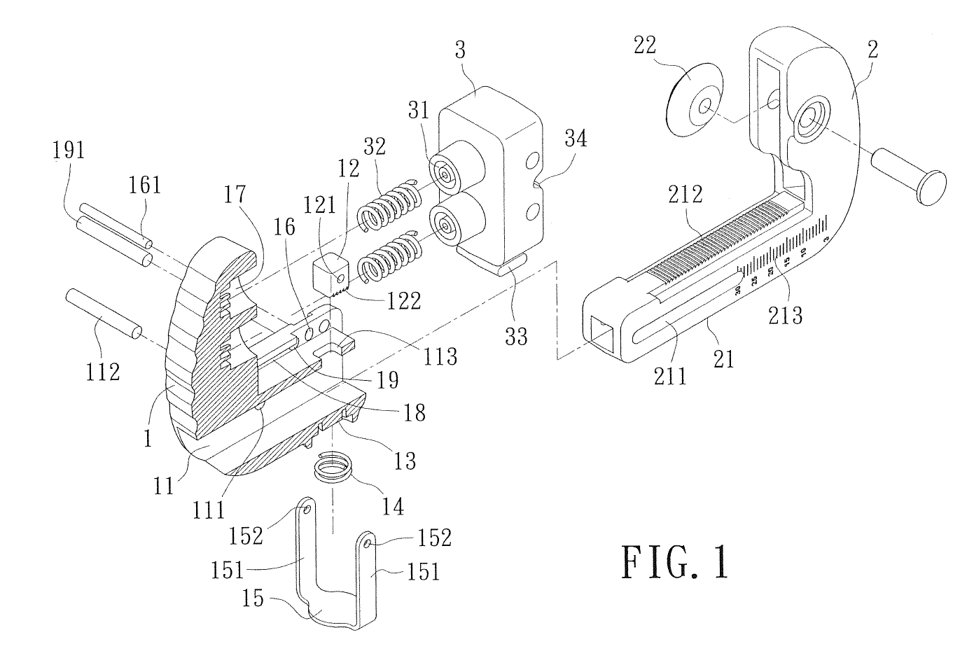

Refer to FIG. 1, a tube cutter of the present invention mainly includes a main body 1, a moveable member 2 and an elastic pressing member 3.

A slot 11 is mounted on a lower part of the main body 1. A stopping hole 111 that allows a stopping rod 112 to pass through is penetrated through a side surface of the slot 11. An opening hole 113 for moveably mounting a positioning block 12 is arranged at the slot 11. A positioning hole 121 is arranged at and penetrating through one side surface of the positioning block 12 and a jagged positioning portion 122 is formed on a bottom surface of the positioning block 12. A positioning projection 13 is disposed on the bottom surface of the main body 1 at the position corresponding to the opening hole 113 and a pressing elastic part 14 is arranged around the positioning projection 13. A press member 15 is arranged at and against the bottom end of the pressing elastic part 14. A lug 151 is projecting upward from each of two sides of the press member 15 and a positioning hole 152 corresponding to the positioning hole 121 of the positioning block 12 is mounted on each lug 151. A long hole 16 that is corresponding to the positioning hole 121 of the positioning block 12 and used for mounting a positioning rod 161 is set on the main body 1. By the positioning rod 161 being passed through the long hole 16, the positioning holes 152 on the lugs 151 of the press member 15 and the positioning hole 121 of the positioning block 12, the positioning block 12 together with the pressing elastic part 14 and the press member 15 is assembled on the main body 1. Moreover, mounting holes 17 are set on the main body 1, over the slot 11. A sliding groove 18 is disposed on the main body 1 and is located between the slot 11 and the mounting holes 17. A stopping hole 19 is mounted on an outer end of the sliding groove 18 and is used for receiving a stopping rod 191.

The moveable member 2 includes a rod portion 21 extended from one end thereof corresponding to the slot 11 of the main body 1. A long slot 211 is mounted on a side surface of the rod portion 21. The stopping rod 112 that penetrates the stopping hole 111 of the slot 11 is passed through the long slot 211 to be stopped. A jagged stopping portion 212 is formed on a top surface of the rod portion 21 and is corresponding to the jagged positioning portion 122 of the positioning block 12 of the main body 1. A size label portion 213 is arranged at a side surface of the rod portion 21. A cutting blade 22 is pivotally connected to one side of the moveable member 2 facing the main body 1.

The elastic pressing member 3 includes mounting projections 31 corresponding to the mounting holes 17 of the main body 1. A supporting elastic part 32 is arranged between the mounting projection 31 and the mounting hole 17 of the main body 1. A sliding block 33 corresponding to the sliding groove 18 of the main body 1 is disposed on the bottom of the elastic pressing member 3. Thus the elastic pressing member 3 is sliding in the sliding groove 18 by the sliding block 33 and is stopped by the stopping rod 191 in the stopping hole 19 of the main body 1. Two rotating wheels 34 corresponding to the cutting blade 22 of the moveable member 2 are pivotally connected to the elastic pressing member 3.

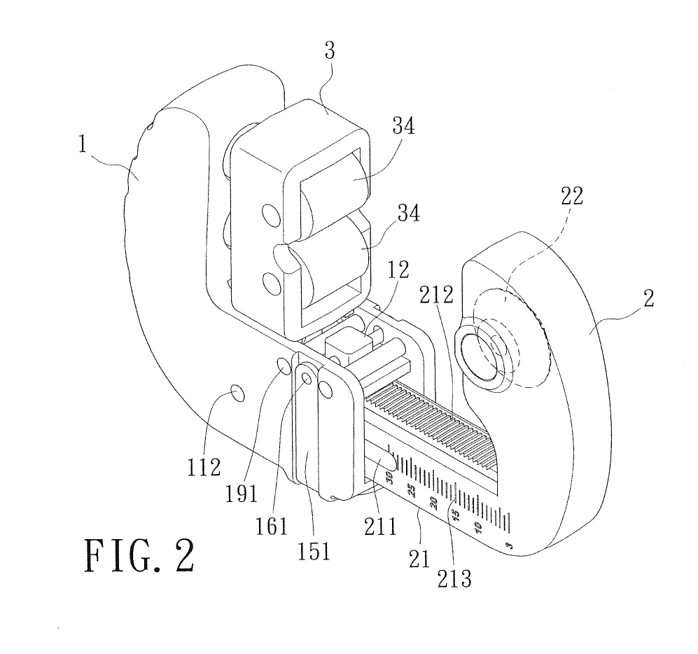

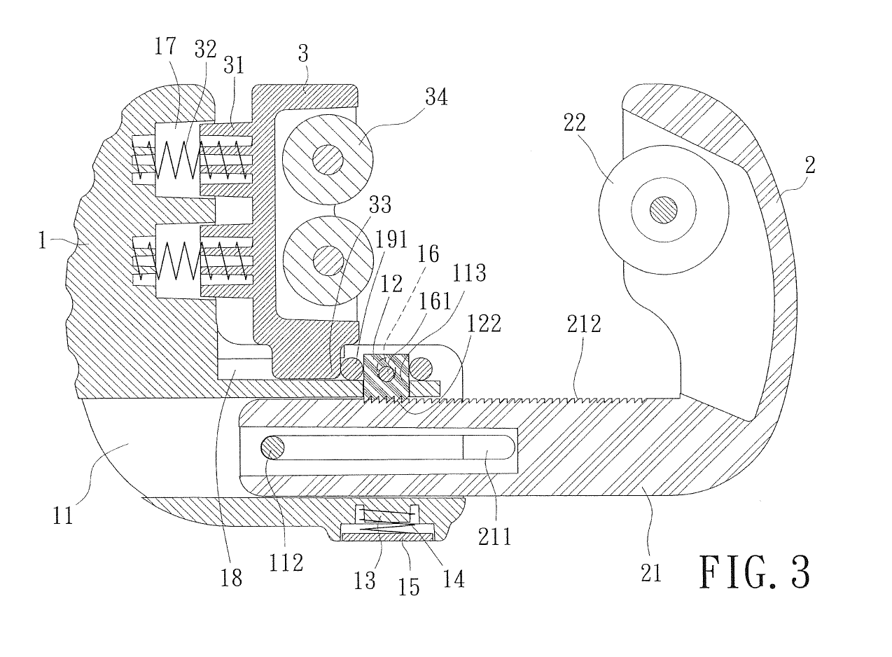

While being assembled, please refer to FIG. 2 and FIG. 3. The rod portion 21 of the moveable member 2 is mounted into the slot 11 of the main body 1. And the stopping rod 112 penetrated through the stopping hole 111 of the slot 11 is passed through the long slot 211 of the rod portion 21. Thus the displacement of the rod portion 21 is restricted by the stopping rod 112. At the same time, the jagged positioning portion 122 on the positioning block 12 of the main body 1 is mounted and positioned on the jagged stopping portion 212 of the rod portion 21 by supporting elastic force of the pressing elastic part 14. The supporting elastic part 32 is arranged between the mounting projection 31 of the elastic pressing member 3 and the mounting hole 17 of the main body 1. And the sliding block 33 on the bottom of the elastic pressing member 3 is mounted into the sliding groove 18 of the main body 1. Thus the sliding distance of the sliding block 33 is restricted by the stopping rod 191 in the stopping hole 19.

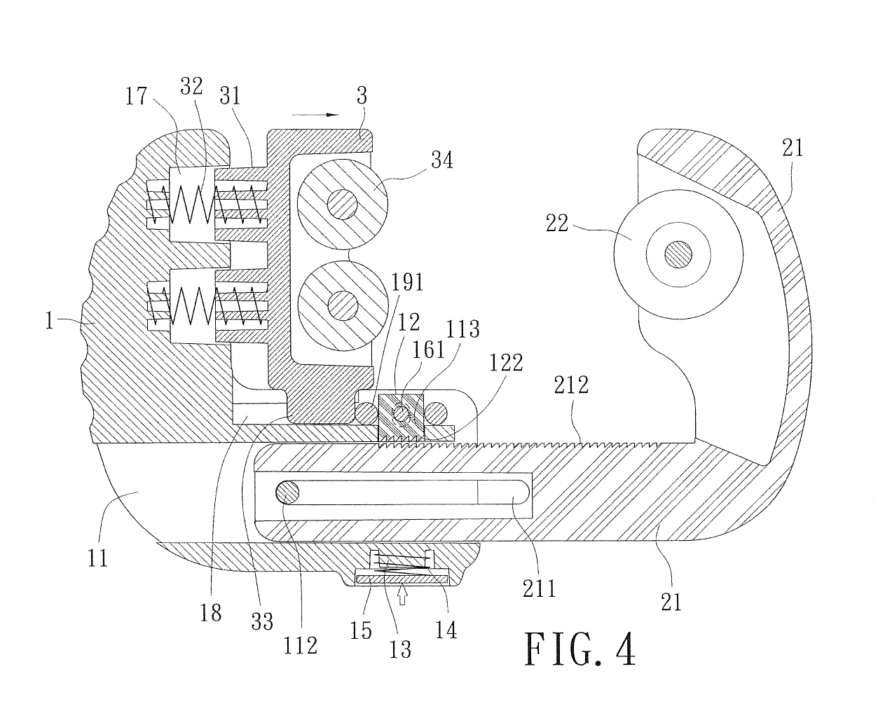

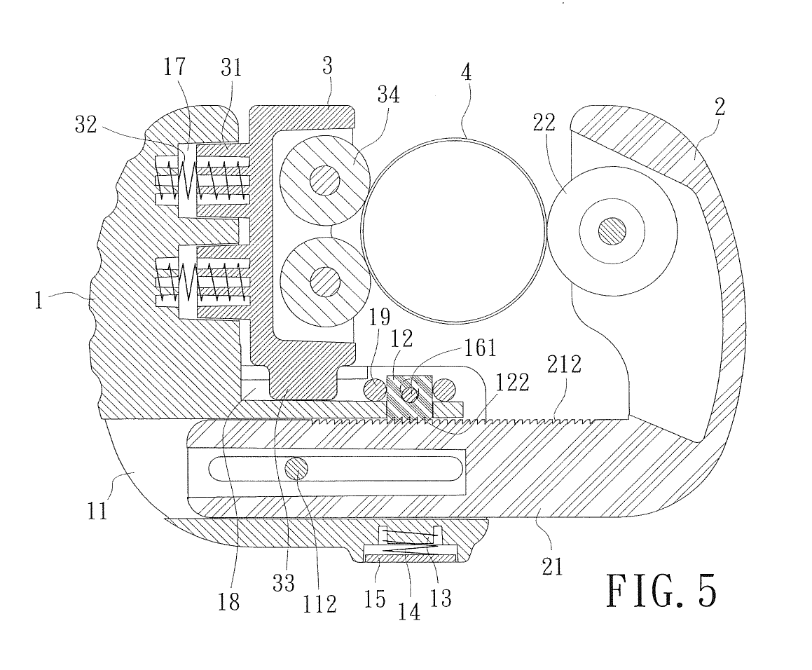

As shown in FIG. 4, the user applies a force to press the press member 15 of the main body 1 while adjusting the tube cutter of the present invention. Then the press member 15 presses the pressing elastic part 14 to move inward and the lug 151 of the press member 15 drives the positioning block 12 to move within the long hole 16 by the positioning rod 161. Thus the jagged positioning portion 122 of the positioning block 12 is released from the jagged stopping portion 212 of the rod portion 21. Now the moveable member 2 can be moved and adjusted within the slot 11 of the main body 1 by the rod portion 21. After being adjusted to a proper position, no more force is applied to the press member 15. Then the jagged positioning portion 122 of the positioning block 12 is mounted and positioned on the jagged stopping portion 212 of the rod portion 21 again by supporting elastic force of the pressing elastic part 14. Thus a tube member 4 the user intends to cut is clipped and positioned between the cutting blade 22 of the moveable member 2 and the rotating wheels 34 of the elastic pressing member 3. Refer to FIG. 5, while in use, the cutting blade 22 presses tightly on the outer surface of the tube member 4 and rotate the main body 1 so as to make the cutting blade 22 cut the outer surface of the tube member 4. At the moment, the elastic pressing member 3 is driven by supporting elastic force of the supporting elastic part 32 arranged between the elastic pressing member 3 and the main body 1 so as to push the tube member 4 against the cutting blade 22 of the moveable member 2 tightly. Thus the tightness between the tube member 4 and the cutting blade 22 doesn't need to be adjusted during the cutting process. Therefore the tube member 4 is cut smoothly.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A tube cutter comprising a main body, a moveable member and an elastic pressing member; wherein
the main body includes a slot mounted on a lower part thereof; a penetrating opening hole for moveably mounting a positioning block is arranged at the slot and a positioning hole is arranged at and penetrating through a side surface of the positioning block; a jagged positioning portion is formed on a bottom surface of the positioning block while a positioning projection corresponding to the opening hole is disposed on a bottom surface of the main body; a pressing elastic part is arranged around the positioning projection and a press member is arranged at and against a bottom end of the pressing elastic part; a lug is projecting upward from each of two sides of the press member and a positioning hole corresponding to the positioning hole of the positioning block is mounted on the lug; a long hole corresponding to the positioning hole of the positioning block and used for mounting a positioning rod is set on the main body; by the positioning rod being passed through the long hole, the positioning hole on the lug of the press member and the positioning hole of the positioning block, the positioning block together with the pressing elastic part and the press member is assembled on the main body;
mounting holes are set on the main body and located over the slot; a sliding groove is disposed on the main body and is located between the slot and the mounting holes; a stopping hole is mounted on an outer end of the sliding groove and is used for receiving a stopping rod;
the moveable member includes a rod portion and a cutting blade; the rod portion is extended from one end thereof and corresponding to the slot of the main body; a jagged stopping portion is formed on a top surface of the rod portion and is corresponding to the jagged positioning portion of the positioning block of the main body; the cutting blade is pivotally connected to one side of the moveable member corresponding to the main body; and
the elastic pressing member includes mounting projections, supporting elastic parts, a sliding block and rotating wheels; the mounting projections are corresponding to the mounting holes of the main body and each supporting elastic part is arranged between the mounting projection and the mounting hole of the main body; the sliding block corresponding to the sliding groove of the main body is disposed on the bottom of the elastic pressing member; the elastic pressing member is sliding in the sliding groove by the sliding block and is stopped by the stopping rod in the stopping hole of the main body; the rotating wheels corresponding to the cutting blade of the moveable member are pivotally connected to the elastic pressing member.

2. The device as claimed in claim 1, wherein a stopping hole that allows a stopping rod to pass through is penetrated through a side surface of the slot of the main body; a long slot is mounted on a side surface of the rod portion of the moveable member; the stopping rod of the stopping hole in the slot of the main body is passed through the long slot to be stopped.

3. The device as claimed in claim 1, wherein a size label portion is arranged at an outer surface of the rod portion of the moveable member.
